(19) United States
(12) Patent Application Publication
(10) Pub. No.: US 2012/0171367 A1
(43) Pub. Date: Jul. 5, 2012

(54) DISPLACEMENT GOLD PLATING SOLUTION AND METHOD FOR FORMING CONNECTING PORTION

(76) Inventor: Rie Kikuchi, Hiratsuka-shi (JP)

(21) Appl. No.: 13/496,746

(22) PCT Filed: Apr. 15, 2011
(86) PCT No.: PCT/JP2011/059351

§ 371 Date: Mar. 16, 2012

(30) Foreign Application Priority Data
Aug. 27, 2010 (JP) 2010-190195

(51) Int. Cl. B05D 5/12; B05D 1/36; C09D 5/00

(52) U.S. Cl. 427/125; 106/1.23

(57) ABSTRACT

The present invention provides a displacement gold plating solution and a plating treatment technology capable of realizing a uniform film thickness when forming a connecting portion obtained by sequentially plating a nickel layer, a palladium layer, and a gold layer in layers. The present invention provides a displacement gold plating solution for forming a connecting portion obtained by sequentially plating a nickel layer, a palladium layer, and a gold layer in layers on a conductor layer containing a conductive metal. The displacement gold plating solution contains a gold cyanide salt, a complexing agent, and a copper compound. A molar ratio of the complexing agent and the copper compound in the displacement gold plating solution is in a range of complexing agent/copper ion=1.0 to 500. A compound formed from the complexing agent and the copper compound has a stability constant of 8.5 or higher at a pH of between 4 and 6.

### FIELD OF THE INVENTION

The present invention relates to a displacement gold plating solution. In particular, the present invention relates to a displacement gold plating treatment technology for forming a connecting portion of an electronic component, a semiconductor component or the like for soldering, wire bonding or the like.

### BACKGROUND ART

Various kinds of printed-circuit boards and packages have recently existed as electronic components or semiconductor components. Examples of so-called packages include a lead frame, BGA (ball grid array), LGA (land grid array package), QFP (quad flat package), and a mini mold package. These packages have been improved day by day in terms of miniaturization and an increase of the number of pins owing to request for high-density mounting, and demand characteristics tend to be increasingly severe.

Soldering or wire bonding has been conventionally used as connecting means in these electronic components and semiconductor components and have been established as a bonding technology which is indispensable in mounting the package on a printed-circuit board such as a printed-wiring board.

As a mounting technology of electronic components or the like, a connecting portion is formed on a conductive metal surface constituting a wiring circuit, a land, a terminal or the like when wire bonding, soldering or the like is used for connection of electronic components. For example, there has been known a technology for subjecting a surface of a conductive metal such as copper to the treatment of nickel plating, palladium plating, and gold plating to form a connecting portion obtained by sequentially plating a nickel layer, a palladium layer, and a gold layer in layers (see Patent Literature 1). In the connecting portion, a nickel layer is formed on a surface of a conductive metal using an electroless nickel solution; a palladium layer is formed using an electroless palladium solution; and a gold layer is further formed using an electroless gold plating solution.

For example, a displacement gold plating solution containing a gold cyanide compound, a carboxylic acid such as an alkane sulfonic acid, a pyridine sulfonic acid, or an oxycarboxylic acid, and a phosphoric acid salt has been proposed as the electroless gold plating solution forming the gold layer (see Patent Literature 2). There has been also known a substitutional electroless plating solution containing at least one buffering agent selected from the group consisting of a gold cyanide salt, a π electron-excessive aromatic heterocyclic compound having 3 or more nitrogen atoms in a molecule, sulfurous acid, phosphorous acid, and a salt thereof (see Patent Literature 3).

These displacement gold plating solutions deposit gold by a substitution reaction with a base metal. When the suitable substitution reaction with a base metal cannot be performed, uniform gold plating treatment may not be realized. The displacement gold plating solution of Patent Literature 2 can realize uniform gold plating treatment without excessively corroding a base copper or a base nickel material. The displacement gold plating solution of Patent Literature 3 enables gold plating treatment while local corrosion of a grain boundary part in a base nickel plating film is suppressed. However, because the substitution reaction with a base metal tends to be suppressed for the displacement gold plating solutions of Patent Literatures 2 or 3, gold plating having a sufficient film thickness may not be obtained.

Furthermore, when the connecting portion obtained by sequentially plating a nickel layer, a palladium layer, and a gold layer in layers is formed, for example, on surfaces of pads having areas of varying size, generation of a large variation of the film thickness of the gold layer is pointed out. When the latest printed-circuit board is taken as an example, examples of the pad for forming the connecting portion include rectangular pads of various sizes having 0.1 mm to 3 mm on a side. When the connecting portion is formed on the pad surface of such a substrate, a remarkable variation of the film thickness of the gold layer formed on each pad occurs by a difference in a plating area thereof. Because a plating film formed by displacement gold plating tends to be thinned on a pad having a larger area, the gold layer of the connecting portion formed on the pad having a larger area is thickened in all the pads on the substrate in order to secure a practical bonding characteristic. In this case, a gold plating film having an excessive film thickness is formed on the pad having a smaller area. It is also pointed out that the formation of the gold plating film having an excessive film thickness leads to an increase of manufacturing cost.

### PRIOR ART DOCUMENTS

### Patent Literatures

Patent Literature 1: Japanese Patent Application Laid-Open No. 9-8438
Patent Literature 2: Japanese Patent Application Laid-Open No. 2004-190093
Patent Literature 3: Japanese Patent No. 3948737

### SUMMARY OF THE INVENTION

### Problems to be Solved by the Invention

The present invention has been made against a background of the above-mentioned situation. The present invention provides a displacement gold plating treatment technology capable of realizing a uniform film thickness when a connecting portion provided on a printed-circuit board such as a printed-wiring board, as a mounting technology for an electronic component or the like, specifically a connecting portion obtained by sequentially plating a nickel layer, a palladium layer, and a gold layer in layers is formed. The present invention provides a displacement gold plating treatment technology capable of suppressing a variation of a film thickness of a gold layer of a connecting portion formed on each of pads even when a portion forming the connecting portion is a substrate having pads having areas of varying size and of realizing a gold plating film having a uniform thickness.

### Means for Solving the Problems

A connecting portion obtained by sequentially plating a nickel layer, a palladium layer, and a gold layer in layers has been diligently studied in order to solve the above-mentioned problem. As a result, a phenomenon has been found, in which a displacement gold plating film to be formed is uniformed by adding a copper compound to a displacement gold plating solution when the palladium layer is subjected to displacement gold plating treatment, and the present invention has been accomplished.

The present invention is a displacement gold plating solution for forming a connecting portion obtained by sequentially plating a nickel layer, a palladium layer, and a gold layer in layers on a conductor layer containing a conductive metal, wherein the displacement gold plating solution comprises a gold cyanide salt, a complexing agent, and a copper compound; a molar ratio of the complexing agent and the copper compound in the displacement gold plating solution is in a range of complexing agent/copper ion=1.0 to 500; and a compound formed from the complexing agent and the copper compound has a stability constant of 8.5 or more at a pH of between 4 and 6.

In displacement gold plating treatment, gold is deposited by a substitution reaction with a base metal. However, according to the present inventor's study, it was found out that nickel as an underlayer of the palladium layer in the connecting portion in the present invention contributes to the substitution reaction, and the degree of progression of a substitution reaction with nickel varies according to a state of a palladium plating film forming the palladium layer. It has been found that, in particular, when the film thickness of the palladium layer is 0.5 μm or less, the palladium plating film tends to be a so-called porous state (the whole surface of the nickel layer is not completely covered, and the nickel layer is partially exposed). That is, it was assumed that because a variation of the substitution reaction in the displacement gold plating treatment was generated according to the covering state of the palladium layer forming the connecting portion, it was difficult to form a uniform gold plating film. Then, when the displacement gold plating treatment is performed with use of the displacement gold plating solution obtained by adding a copper compound to the displacement gold plating solution containing a gold cyanide salt and a complexing agent, a gold plating film having a uniform thickness can be formed. It is considered that the copper compound added to the displacement gold plating solution uniformly progresses the substitution reaction with nickel. It is considered that a uniform gold plating film can be formed by an operation of the added copper compound accelerating the substitution reaction and an operation of the copper compound suppressing acceleration of excessive deposition caused by compound formation with the complexing agent in a portion where the nickel layer as an underlayer of the palladium layer is largely exposed.

When the molar ratio of the complexing agent and the copper compound is in a range of complexing agent/copper ion=1.0 to 500, the copper ion in the solution can effectively control the substitution reaction with gold and nickel. When the molar ratio is lower than 1.0, a variation of the film thickness tends to increase. When the molar ratio is higher than 500, addition of excessive chemicals leads to an increase of a manufacturing cost although no problems in characteristic occur. Because copper has an ionization tendency lower than that of nickel, copper may codeposit with gold. The stability constant of the compound formed from the complexing agent and the copper compound at a pH of between 4 and 6 is required to be 8.5 or higher in order to suppress the codeposition of copper with gold. The amount of the copper compound, in terms of copper, added to the displacement gold plating solution is preferably in a range from 2 to 200 ppm, and more preferably a range from 5 to 100 ppm. When the amount of the copper compound, in terms of copper, is less than 2 ppm, the variation of the thickness of the gold plating film to be formed tends to be suppressed. However, a deposit rate of gold is considerably reduced to lengthen a lead time in a manufacturing process, thereby leading to an increase in a manufacturing cost. On the other hand, when amount of the copper compound, in terms of copper, is higher than 200 ppm, gold is deposited rapidly to increase a tendency of generating a variation of the thickness of the gold plating film, which leads to an increase in the manufacturing cost due to addition of excessive chemicals.

The complexing agent in the displacement gold plating solution of the present invention is preferably at least one selected from the group consisting of ethylenediaminetetraacetic acid, hydroxyethylethylenediaminetriacetic acid, diethylenetriaminepentaacetic add, propanediaminetetraacetic acid, 1,3-diamino-2-hydroxypropanetetraacetic acid, cyclohexanediaminetetraacetic acid, ethylenediaminedisuccinic acid, and a sodium salt, a potassium salt or an ammonium salt thereof. These complexing agents have a stability constant of 8.5 or higher in terms of the compound formed from the complexing agent and the copper compound at a pH of between 4 and 6 and tend to form a uniform gold plating film.

Examples of the stability constant of the compound formed from the complexing agent and the copper compound at a pH of between 4 and 6 include 10.4 to 14.2 for ethylenediaminetetraacetic acid; 10.1 to 13.4 for hydroxyethylethylenediaminetriacetic acid; 9.4 to 13.9 for diethylenetriaminepentaacetic acid; 9.0 to 13.0 for propanediaminetetraacetic acid; 8.7 to 12.7 for 1,3-diamino-2-hydroxypropanetetraacetic acid; 11.4 to 15.2 for cyclohexanediaminetetraacetic acid; and 10.0 to 13.7 for ethylenediaminedisuccinic acid. The stability constant of the compound formed from the copper compound of the complexing agent at a pH of between 4 and 6 can be simply calculated by multiplying a stability constant of a generally known complexing agent by a concentration fraction calculated using an acid dissociation constant of the complexing agent and a pH value. When a compound having such a stability constant is formed from the complexing agent and the copper compound, a uniform gold plating film is stably formed. Stability constants of some complexing agents at a pH of between 4 and 6 are lower than 8.5. However, when the complexing agent having such a stability constant of lower than 8.5 is used, a tendency of generating a variation of the thickness of the gold plating film to be formed increases.

The copper compound in the displacement gold plating solution of the present invention is preferably at least one selected from the group consisting of copper cyanide, copper sulfate, copper nitrate, copper chloride, copper bromide, copper potassium cyanide, copper thiocyanate, ethylenediaminetetraacetic acid copper disodium salt tetrahydrate, copper pyrophosphate, and copper oxalate. These copper compounds are water-soluble copper compounds supplying copper ions.

In the displacement gold plating solution of the present invention, gold (I) potassium cyanide and gold (II) potassium cyanide can be used as the gold cyanide salt. Gold (I) potassium cyanide is particularly preferable. A concentration of the gold cyanide salt in terms of a metal gold is preferably in a range of 0.5 to 10 g/L, and more preferably 1 to 5 g/L. When a gold concentration is lower than 0.5 g/L, progression of plating is slow. When the gold concentration is higher than 10 g/L, the manufacturing cost is impractically increased. A known pH adjuster, a buffering agent or the like can be also added to the displacement gold plating solution of the present invention.

The displacement gold plating treatment is preferably performed with a solution temperature of the displacement gold plating solution of the present invention at from 70 to 95° C. and pH of between 4 and 6. When the solution temperature is lower than 70° C., progression of plating is slow. When the solution temperature is higher than 95° C., realization in a production line is complicated. When the pH is lower than pH 4, a water-soluble gold salt is unstable. When the pH is higher than pH 6, progression of plating is slow.

The present invention relates to a method for forming a connecting portion obtained by sequentially plating a nickel layer, a palladium layer, and a gold layer in layers on a conductor layer containing a conductive metal, wherein the gold layer includes a gold cyanide salt and a complexing agent and is formed by the displacement gold plating treatment with use of a displacement gold plating solution according to the present invention to which a copper compound is added.

The method for forming the connecting portion of the present invention can suppress the variation of the film thickness of the gold layer of the connecting portion formed on each pad even when a portion forming the connecting portion is a substrate having pads having areas of varying size, and can form the gold plating film having a uniform thickness. When the areas of the pads differ, a variation of the covering state of the palladium layer in each pad is generated. However, the present invention can form the gold plating film having a uniform thickness on the pads having areas of varying size. Therefore, the formation of the gold plating film having an excessive film thickness can be avoided, and the manufacturing cost can be suppressed.

It is preferable that the thickness of the palladium layer is 0.05 μm to 0.5 μm and the thickness of the gold layer is 0.05 μm to 0.2 μm in the method for forming the connecting portion of the present invention. When the thickness of the palladium layer is less than 0.05 μm, an effect of preventing oxidization of the surface of the nickel layer is insufficient. The insufficient effect may generate diffusion of copper, and oxidization and diffusion of nickel, or the like, to deteriorate bonding characteristics of wire bonding and lead-free soldering. On the other hand, when the thickness is more than 0.5 μm, a good intermetallic compound is not obtained when solder bonding is performed, which causes deterioration of bonding characteristics. When the thickness of the gold layer is less than 0.05 μm, good gold-gold bonding of the gold layer and the gold wire in wire bonding cannot be realized and the bonding characteristic will be deteriorated. The upper limit value of the gold layer is limited for the economical reason. Usually, the upper limit value is preferably up to 0.2 μm.

The purity of the gold layer formed by the displacement gold plating solution of the present invention is preferably 99% by mass or more. When the purity is less than 99% by mass, bonding reliability may be reduced. Thereby, the purity of the gold layer is preferably 99% by mass or more.

In the method for forming the connecting portion of the present invention, the composition of the nickel layer is not particularly limited. However, a nickel-phosphorus alloy, a nickel-boron alloy or the like can be also applied. When the nickel-phosphorus alloy is employed as the nickel layer, the nickel-phosphorus alloy preferably contains 3 to 10% by weight of phosphorus. The method for forming the nickel layer is not also particularly limited. A known technology can be employed for forming the nickel layer. The method for forming the nickel layer can be based, for example, on electroless nickel plating. The film thickness of the nickel layer is preferably 0.1 to 20 μm. When the film thickness is less than 0.1 μm, a diffusion suppression effect of the base metal is reduced, which does not improve bonding reliability. Even when the film thickness is more than 20 μm, the diffusion suppression effect of the base metal is not further improved, which is not economical. Thereby, it is not preferable when the film thickness is less than 0.1 μm and more than 20 μm.

The composition of the palladium layer is not either particularly limited. However, pure palladium, a palladium-phosphorus alloy or the like can be applied. When the palladium-phosphorus alloy is employed as the palladium layer, the palladium-phosphorus alloy preferably contains 7% by weight or less of phosphorus. A known technology can be employed for forming the palladium layer. The method for forming the palladium layer can be based on electroless palladium plating, for example.

In the method for forming the connecting portion according to the present invention, the conductive metal forming the connecting portion is not particularly limited. The conductive metal can be applied to copper, a copper alloy, tungsten, molybdenum, aluminum or the like.

### Advantages Effects of Invention

The present invention enables the displacement gold plating treatment providing a uniform film thickness when the connecting portion provided on the printed-circuit board such as the printed-wiring board and obtained by sequentially plating the nickel layer, the palladium layer, and the gold layer in layers is formed. Even when the portion forming the connecting portion is the substrate having the pads having areas of varying size, the variation of the film thickness of the gold layer of the connecting portion formed on each pad can be suppressed, and the gold plating film having a uniform thickness can be realized.

### BRIEF DESCRIPTION OF THE DRAWING

FIG. 1 is a graph showing the relationship between a Pd film thickness and a current value.

### BEST MODE FOR CARRYING OUT THE INVENTION

Hereinafter, embodiments of the present invention will be described.

First Embodiment: In the present embodiment, the results of confirming the effect of addition of a copper compound using ethylenediaminetetraacetic acid disodium as the complexing agent and copper sulfate as the copper compound are shown. In the first embodiment, a nickel layer and a palladium layer were formed on an evaluation board on which a plurality of pads having areas of varying size were formed. The evaluation board was subjected to a displacement gold plating treatment. A thickness of gold plating for each pad was measured to perform evaluation. The composition of a displacement gold plating solution is as follows.

| | |
|---|---|
| Gold (I) potassium cyanide: | 2.9 g/L (2 g/L in terms of gold) |
| Ethylenediaminetetraacetic acid | 30 g/L |
| disodium: | |
| Copper sulfate: | 0 to 500 ppm in terms of copper |
| Citric acid: | 25 g/L |
| Potassium hydrate (pH adjuster): | appropriate amount |
| pH: | 4 to 6 |
| Solution temperature: | 85° C. |

Evaluation was made on displacement gold plating solutions containing the copper compound at 5 ppm (Example 1), 20 ppm (Example 2), 50 ppm (Example 3), 80 ppm (Example 4), and 100 ppm (Example 5) in terms of copper and displacement gold plating solutions containing the copper compound at 0 ppm (Comparative Example 1, 5 ppm of thallium was added instead of the additive-free copper compound) and 500 ppm (Comparative Example 2) in terms of copper for comparison.

Used as the evaluation board was a substrate having a circuit formed by removing unnecessary copper from a commercially available copper clad laminate by etching, and using a solder resist. A plurality of square pads having 0.1 mm to 3.0 mm on a side are provided on the evaluation board. There was prepared an evaluation board obtained by sequentially plating a nickel layer and a palladium layer in layers on a surface of each pad using an electroless nickel plating solution and an electroless palladium plating solution which will be shown below.

Electroless Nickel Plating Solution:

| Nickel sulfate: | 21 | g/L |
|---|---|---|
| Sodium phosphinate: | 25 | g/L |
| Lactic acid: | 27 | g/L |
| Propionic acid: | 2.2 | g/L |
| Lead ion: | 1 | ppm |
| Solution pH: | pH 4.6 | |
| Plating solution temperature: | 85° | C. |
| Plating time: | 18 | minutes |
| Target film thickness: | 6 | μm |

Electroless Palladium Plating Solution:

| Palladium chloride: | 2 | g/L |
|---|---|---|
| Ethylenediamine: | 7 | g/L |
| Sodium phosphinate: | 5 | g/L |
| Solution pH: | pH 7 | |
| Plating solution temperature: | 50° | C. |
| Plating time: | 8 | minutes |
| Target film thickness: | 0.1 | μm |

The prepared evaluation board was subjected to displacement gold plating treatment with a target gold plating thickness of 0.15 μm (plating time: 20 minutes) using displacement gold plating solutions (Examples 1 to 5, Comparative Examples 1 and 2). The thickness of the displacement gold plating in each square pad was measured with a fluorescent X-ray measuring device (SFT-9550: manufactured by SII NanoTechnology Inc.). The thicknesses of pads were measured at six positions including the pads that were independent (not electrically connected) and had a side of 0.4 mm (No. 1), 0.8 mm (No. 2), and 3.0 mm (No. 3), and the pads that were electrically connected by a circuit and had a side of 0. 4 mm (No. 4), 0.8 mm (No. 5), and 3.0 mm (No. 6). A mean film thickness value and a CV (Coefficient of variation) value (%) showing uniformity of a film thickness were calculated from the measured values of the pads of Nos. 1 to 6. The results are shown in Table 1. Numerical values of the leftmost column of Table 1 are Nos. of the measured pads, and the unit of the each measured value is μm.

TABLE 1

| | Example | Example | Example | Example | Example | Comparative | Comparative |
|---|---|---|---|---|---|---|---|
| | 1 | 2 | 3 | 4 | 5 | Example 1 | Example 2 |
| 1 | 0.141 | 0.142 | 0.178 | 0.189 | 0.185 | 0.214 | 0.211 |
| 2 | 0.115 | 0.121 | 0.152 | 0.155 | 0.153 | 0.164 | 0.168 |
| 3 | 0.093 | 0.102 | 0.126 | 0.133 | 0.132 | 0.089 | 0.101 |
| 4 | 0.103 | 0.103 | 0.135 | 0.136 | 0.130 | 0.146 | 0.133 |
| 5 | 0.114 | 0.112 | 0.136 | 0.148 | 0.141 | 0.140 | 0.147 |
| 6 | 0.121 | 0.126 | 0.150 | 0.166 | 0.168 | 0.137 | 0.164 |
| Mean | 0.11 | 0.12 | 0.15 | 0.15 | 0.15 | 0.15 | 0.15 |
| CV | 14.0 | 13.2 | 12.5 | 13.6 | 14.2 | 27.3 | 24.0 |

The results in Table 1 revealed as follows: In Comparative Example 1 in which the copper compound was not added, a CV value was 27.3%, which generated a remarkable variation. However, in Examples 1 to 5, the CV value was 15% or lower, which improved the film thickness uniformity of the gold plating film of each pad. From the result of Comparative Example 2, the following tendency was observed. When a large number of copper compounds were added, film thickness uniformity was deteriorated.

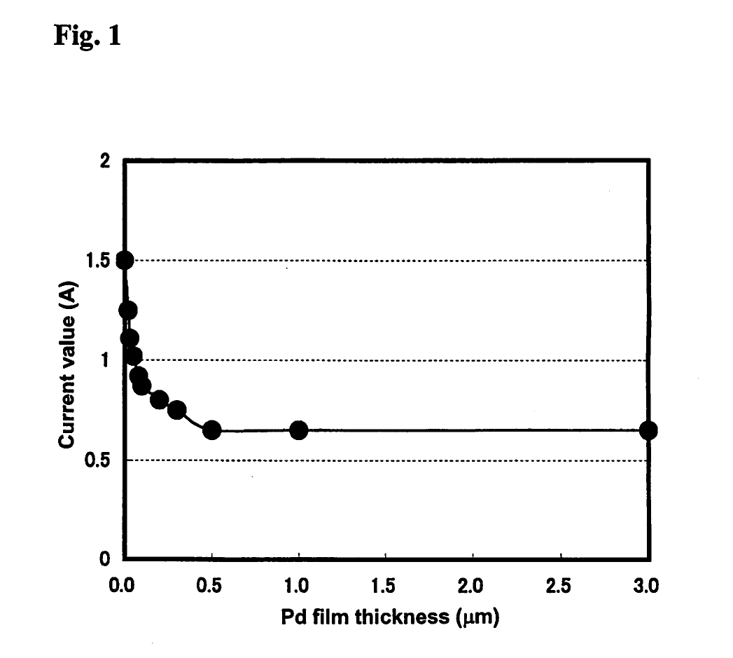

Here, the results obtained by investigating the relationship between the thickness of the palladium layer formed on the evaluation board and the covering state thereof are described. An examination method was as follows: A 5 cm×7 cm copper plate having a thickness of 0.3 mm was subjected to nickel plating coating with a thickness of 6 μm. Positive electrodes on which a palladium plating film having the respective thicknesses were formed on the nickel surface. The positive electrode plate and a Pt/Ti electrode as a negative electrode were immersed in a 1% citric acid solution with the electrode plates facing each other. A certain voltage was applied thereto, and a current value after 10 minutes was measured. The plating solutions forming the nickel plating film and the palladium plating film are the same as the above-mentioned plating solutions. The thickness of the palladium plating film was controlled by controlling a plating time. The plating time was adjusted with the film thickness of palladium (Pd) set to the target thickness of 0.2 μm to 3.0 μm. The results obtained by immersing the electrodes in the 1% citric acid solution, applying a certain voltage, and measuring the current value after 10 minutes are shown in FIG. 1. The Pd film thickness shown by the horizontal axis of FIG. 1 is the target plating thickness value calculated by the plating time.

As shown in FIG. 1, it was confirmed that the current value rapidly increased when the thickness of palladium was 0.5 μm or less. This phenomenon correlates with an increase in a so-called porous state, that is, an increase in the existence of the partially exposed nickel layer when the thickness of the palladium plating film is 0.5 μm or less. The phenomenon is proportional to an amount of leaching of nickel provided on the layer below the palladium layer. It is considered that the substitution reaction of gold and nickel progresses according to the leaching of nickel, and the gold layer is formed on the palladium layer. Therefore, when the thickness of palladium is more than 0.5 μm, sufficient leaching of nickel is not obtained, which tends to hardly form the gold layer having a predetermined film thickness.

Second Embodiment: The results of investigating a molar ratio of a complexing agent and a copper compound when ethylenediaminetetraacetic acid disodium is used as the complexing agent and copper sulfate is used as the copper compound in the present embodiment are described below.

An amount of ethylenediaminetetraacetic acid disodium added was changed on the basis of the above-mentioned Example 3 (50 ppm in a copper conversion amount) to adjust a molar ratio of a composition of a displacement gold plating solution. Uniformity of a thickness of gold plating was evaluated for displacement gold plating solutions having a molar ratio, as a molar ratio of complexing agent/copper ion, of 1 (Example 6), a molar ratio of 10 (Example 7), a molar ratio of 50 (Example 8), a molar ratio of 100 (Example 9), a molar ratio of 200 (Example 10), and a molar ratio of 500 (Example 11) and displacement gold plating solutions having a molar ratio of 0 (Comparative Example 3) and a molar ratio of 0.95 (Comparative Example 4) for comparison. Conditions such as an evaluation board, a nickel layer, a palladium layer, and film thickness measurement which are conditions other than the molar ratio are the same as those of the above-mentioned first embodiment. The results of thickness measurement of gold plating formed by the displacement gold plating solutions are shown in Table 2.

TABLE 2

| | Example | Example | Example | Example | Example | Example | Comparative | Comparative |
|---|---|---|---|---|---|---|---|---|
| | 6 | 7 | 8 | 9 | 10 | 11 | Example 3 | Example 4 |
| Molar ratio | 1 | 10 | 50 | 100 | 200 | 500 | 0 | 0.95 |
| 1 | 0.178 | 0.176 | 0.175 | 0.178 | 0.175 | 0.182 | 0.239 | 0.237 |
| 2 | 0.153 | 0.148 | 0.151 | 0.152 | 0.165 | 0.159 | 0.175 | 0.199 |
| 3 | 0.125 | 0.132 | 0.131 | 0.126 | 0.147 | 0.134 | 0.205 | 0.133 |
| 4 | 0.144 | 0.136 | 0.135 | 0.135 | 0.132 | 0.135 | 0.200 | 0.185 |
| 5 | 0.132 | 0.124 | 0.138 | 0.136 | 0.140 | 0.146 | 0.168 | 0.167 |
| 6 | 0.142 | 0.141 | 0.144 | 0.150 | 0.165 | 0.154 | 0.137 | 0.152 |
| Mean | 0.15 | 0.14 | 0.15 | 0.15 | 0.15 | 0.15 | 0.19 | 0.18 |
| CV | 12.8 | 12.7 | 11.0 | 12.5 | 11.0 | 11.8 | 18.8 | 20.5 |

As shown in Table 2, when the molar ratio was lower than 1, a CV value was higher than 15%, which generated a variation of a film thickness of a gold plating film. However, it was found that when the molar ratio was 1 to 500, the CV value was 15% or lower, which improved the film thickness uniformity of the gold plating film of each pad. When the molar ratio was higher than 500, it was difficult to produce the plating solution in view of solubility.

Third Embodiment: In the present embodiment, description is being made of results of investigating complexing agents having different stability constants in terms of a compound formed from a complexing agent and a copper compound, for the case when copper sulfate used as a copper compound.

Evaluation was made on displacement gold plating solutions containing ethylenediaminetetraacetic acid disodium (complexing agent B, Example 12), diethylenetriaminepentaacetic acid (complexing agent A, Example 13), and hydroxyethylethylenediaminetriacetic acid (complexing agent C, Example 14) as the complexing agent having a stability constant 8.5 or higher in terms of the compound formed from the complexing agent and the copper compound at a pH of between 4 and 6, and displacement gold plating solutions containing nitrilotriacetic acid (complexing agent X, Comparative Example 5), hydroxyethyliminodiacetic acid (complexing agent Y, Comparative Example 6), and dihydroxyethylglycine (complexing agent Z, Comparative Example 7) as a complexing agent having a stability constant of lower than 8.5 as a compound at a pH of between 4 and 6 for comparison, on the basis of the above-mentioned Example 3 (50 ppm in a copper conversion amount), as a composition of a displacement gold plating solution. The molar ratio of the complexing agent/copper ion of each displacement gold plating solution was set to 100. Conditions such as an evaluation board, a nickel layer, a palladium layer, and film thickness measurement are the same as those of the above-mentioned first embodiment. The results of thickness measurement of gold plating formed by the displacement gold plating solutions are shown in Table 3. Stability constants at a predetermined pH of the compounds formed from the complexing agents and the copper compound are shown in Table 3.

TABLE 3

| | Example | Example | Example | Comparative | Comparative | Comparative |
|---|---|---|---|---|---|---|
| | 12 | 13 | 14 | Example 5 | Example 6 | Example 7 |
| Complexing agent | B | A | C | X | Y | Z |
| Stability constant | 9.4 | 12.4 | 13.4 | 7.4 | 8.1 | 5.9 |
| (pH) | (pH 4) | (pH 5) | (pH 6) | (pH 4) | (pH 5) | (pH 6) |
| 1 | 0.185 | 0.176 | 0.189 | 0.233 | 0.247 | 0.283 |
| 2 | 0.161 | 0.155 | 0.156 | 0.184 | 0.151 | 0.189 |
| 3 | 0.127 | 0.129 | 0.133 | 0.121 | 0.145 | 0.165 |
| 4 | 0.139 | 0.130 | 0.133 | 0.195 | 0.207 | 0.201 |
| 5 | 0.152 | 0.138 | 0.149 | 0.164 | 0.170 | 0.163 |
| 6 | 0.162 | 0.160 | 0.141 | 0.129 | 0.123 | 0.125 |
| Mean | 0.15 | 0.15 | 0.15 | 0.17 | 0.17 | 0.19 |
| CV | 13.1 | 12.7 | 14.0 | 24.6 | 26.3 | 28.5 |

As shown in Table 3, when the stability constant at a pH of between 4 and 6 was lower than 8.5, a CV value was higher than 20%, which generated a remarkable variation of a film thickness of a gold plating film. On the other hand, it was found that when the stability constant of the compound formed from the complexing agent and the copper compound was 8.5 or higher at a pH of between 4 and 6, the CV value was 15% or lower, which improved the film thickness uniformity of the gold plating film of each pad.

Fourth Embodiment: In the present embodiment, there will be described the results when ethylenediaminetetraacetic acid disodium is used as a complexing agent and various kinds of copper compounds are used. [0049]

Evaluation was made on displacement gold plating solutions containing copper sulfate (a copper-compound A, Example 15) as a copper compound, copper chloride (a copper compound D, Example 16), copper cyanide (a copper compound B, Example 17), and ethylenediaminetetraacetic acid copper disodium salt tetrahydrate (a copper compound F, Example 18), on the basis of the above-mentioned Example 3 (50 ppm in a copper conversion amount), as a composition of a displacement gold plating solution. Conditions such as an evaluation board, a nickel layer, a palladium layer, and film thickness measurement are the same as those of the above-mentioned first embodiment. The results of thickness measurement of gold plating formed by the displacement gold plating solutions are shown in Table 4.

TABLE 4

| | Example 15 | Example 16 | Example 17 | Example 18 |
|---|---|---|---|---|
| Copper | A | D | B | F |
| compound | | | | |
| Molar ratio | 100 | 100 | 100 | 100 |
| 1 | 0.178 | 0.186 | 0.176 | 0.182 |
| 2 | 0.152 | 0.170 | 0.165 | 0.171 |
| 3 | 0.126 | 0.136 | 0.119 | 0.124 |
| 4 | 0.135 | 0.135 | 0.148 | 0.152 |
| 5 | 0.136 | 0.153 | 0.146 | 0.157 |
| 6 | 0.150 | 0.173 | 0.165 | 0.154 |
| Mean | 0.15 | 0.16 | 0.15 | 0.16 |
| CV | 12.5 | 13.2 | 13.2 | 12.6 |

As shown in Table 4, it was found that when various copper compounds were used, a CV value was 15% or higher, and the film thickness uniformity of the gold plating film of each pad was high.

Fifth Embodiment: In the present embodiment, description is being made of the results obtained when various complexing agents are used in combination with various copper compounds.

Evaluation was made on displacement gold plating solutions obtained by combining various complexing agents and various copper compounds as shown in Table 5 on the basis of the above-mentioned Example 3 (50 ppm in a copper conversion amount), and changing the molar ratio to 1 to 500, as a composition of a displacement gold plating solution. Conditions such as an evaluation board, a nickel layer, a palladium layer, and film thickness measurement are the same as those of the above-mentioned first embodiment. The results of thickness measurement of gold plating formed by the displacement gold plating solutions are shown in Table 5. Stability constants at a predetermined pH of the compounds formed from the complexing agents and the copper compound are shown in Table 5.

TABLE 5

| | Example | Example | Example | Example | Example | Example | Example | Example | Example | Example |
|---|---|---|---|---|---|---|---|---|---|---|
| | 19 | 20 | 21 | 22 | 23 | 24 | 25 | 26 | 27 | 28 |
| Complexing agent | D | C | B | A | E | F | G | D | C | B |
| Stability constant | 11.4 | 12 | 13.9 | 10.4 | 11.9 | 13.0 | 8.7 | 13.4 | 13.4 | 11.8 |
| (pH) | (pH 4) | (pH 5) | (pH 6) | (pH 4) | (pH 5) | (pH 6) | (pH 4) | (pH 5) | (pH 6) | (pH 5) |
| Copper | B | C | D | A | E | F | G | H | I | J |
| Molar ratio | 1 | 5 | 10 | 50 | 100 | 200 | 500 | 50 | 50 | 50 |
| 1 | 0.176 | 0.189 | 0.146 | 0.175 | 0.178 | 0.185 | 0.215 | 0.186 | 0.178 | 0.182 |
| 2 | 0.165 | 0.156 | 0.134 | 0.151 | 0.152 | 0.165 | 0.201 | 0.170 | 0.152 | 0.171 |
| 3 | 0.119 | 0.133 | 0.117 | 0.131 | 0.126 | 0.147 | 0.154 | 0.136 | 0.126 | 0.124 |
| 4 | 0.148 | 0.133 | 0.114 | 0.135 | 0.135 | 0.132 | 0.165 | 0.135 | 0.135 | 0.152 |
| 5 | 0.146 | 0.149 | 0.124 | 0.138 | 0.136 | 0.140 | 0.176 | 0.153 | 0.136 | 0.157 |
| 6 | 0.165 | 0.141 | 0.141 | 0.144 | 0.150 | 0.165 | 0.196 | 0.173 | 0.150 | 0.154 |
| Mean | 0.15 | 0.15 | 0.13 | 0.15 | 0.15 | 0.16 | 0.18 | 0.16 | 0.15 | 0.16 |
| CV | 13.2 | 14.0 | 10.1 | 11.0 | 12.5 | 12.6 | 12.7 | 13.2 | 12.5 | 12.6 |

Complexing agent
A: Ethylenediaminetetraacetic acid disodium
B: Diethylenetriaminepentaacetic acid
C: Hydroxyethylethylenediaminetriacetic acid
D: Cyclohexanediaminetetraacetic acid
E: Ethylenediaminedisuccinic acid
F: Propanediaminetetraacetic acid
G: 1,3-Diamino-2-hydroxypropanetetraacetic acid
Copper compound
A: Copper sulfate
B: Copper cyanide
C: Copper nitrate
D: Copper chloride
E: Copper bromide
F: Ethylenediaminetetraacetic acid copper disodium salt tetrahydrate
G: Copper potassium cyanide
H: Copper thiocyanate
I: Copper pyrophosphate
J: Copper oxalate

As shown in Table 5, it was found that a CV value was 15% or lower in each combined displacement gold plating solution, and the film thickness uniformity of the gold plating film of each pad was high.

### INDUSTRIAL APPLICABILITY

The present invention can efficiently form the connecting portion capable of realizing a good bonding characteristic when solder bonding or wire bonding is performed in the mounting process of electronic components, semiconductor components or the like on a printed-circuit board, a package or the like.

1. A displacement gold plating solution for forming a connecting portion obtained by sequentially plating a nickel layer, a palladium layer, and a gold layer in layers on a conductor layer comprising a conductive metal, wherein the displacement gold plating solution comprises a gold cyanide salt, a complexing agent, and a copper compound; a molar ratio of the complexing agent and the copper compound in the displacement gold plating solution is in a range of complexing agent/copper ion=1.0 to 500; and a compound formed from the complexing agent and the copper compound has a stability constant of 8.5 or higher at a pH of between 4 and 6.

2. The displacement gold plating solution according to claim 1, wherein the complexing agent is at least one selected from the group consisting of ethylenediaminetetraacetic acid, hydroxyethyl ethylenediaminetriacetic acid, diethylenetriaminepentaacetic acid, propanediaminetetraacetic acid, 1,3-diamino-2-hydroxypropanetetraaceticacid, cyclohexanediaminetetraacetic acid, ethylenediaminedisuccinic acid, and a sodium salt, a potassium salt or an ammonium salt thereof.

3. The displacement gold plating solution according to claim 1, wherein the copper compound is at least one selected from the group consisting of copper cyanide, copper sulfate, copper nitrate, copper chloride, copper bromide, copper potassium cyanide, copper thiocyanate, ethylenediaminetetraacetic acid copper disodium salt tetrahydrate, copper pyrophosphate, and copper oxalate.

4. A displacement gold plating method using a displacement gold plating solution, the solution defined in claim 1, 3, wherein the displacement gold plating solution has a solution temperature of 70 to 95° C. and a pH of between 4 and 6.

5. A method for forming a connecting portion obtained by sequentially plating a nickel layer, a palladium layer, and a gold layer in layers on a conductor layer comprising a conductive metal, wherein the gold layer comprises a gold cyanide salt and a complexing agent and is formed by a displacement gold plating treatment using a displacement gold plating solution according to claim 1 to which a copper compound is added.

6. The method for forming the connecting portion according to claim 5, wherein the palladium layer has a thickness of 0.05 μm to 0.5 μm and the gold layer has a thickness of 0.05 μm to 0.2 μm.

7. The method for forming the connecting portion according to claim 5, wherein the gold layer has purity of 99% by mass or higher.

8. The displacement gold plating solution according to claim 2, wherein the copper compound is at least one selected from the group consisting of copper cyanide, copper sulfate, copper nitrate, copper chloride, copper bromide, copper potassium cyanide, copper thiocyanate, ethylenediaminetetraacetic acid copper disodium salt tetrahydrate, copper pyrophosphate, and copper oxalate.

9. A displacement gold plating method using a displacement gold plating solution, the solution defined in claim 2, wherein the displacement gold plating solution has a solution temperature of 70 to 95° C. and a pH of between 4 and 6.

10. A displacement gold plating method using a displacement gold plating solution, the solution defined in claim 3, wherein the displacement gold plating solution has a solution temperature of 70 to 95° C. and a pH of between 4 and 6.

11. A displacement gold plating method using a displacement gold plating solution, the solution defined in claim 8, wherein the displacement gold plating solution has a solution temperature of 70 to 95° C. and a pH of between 4 and 6.

12. A method for forming a connecting portion obtained by sequentially plating a nickel layer, a palladium layer, and a gold layer in layers on a conductor layer comprising a conductive metal, wherein the gold layer comprises a gold cyanide salt and a complexing agent and is formed by a displacement gold plating treatment using a displacement gold plating solution according to claim 2 to which a copper compound is added.

13. A method for forming a connecting portion obtained by sequentially plating a nickel layer, a palladium layer, and a gold layer in layers on a conductor layer comprising a conductive metal, wherein the gold layer comprises a gold cyanide salt and a complexing agent and is formed by a displacement gold plating treatment using a displacement gold plating solution according to claim 3 to which a copper compound is added.

14. A method for forming a connecting portion obtained by sequentially plating a nickel layer, a palladium layer, and a gold layer in layers on a conductor layer comprising a conductive metal, wherein the gold layer comprises a gold cyanide salt and a complexing agent and is formed by a displacement gold plating treatment using a displacement gold plating solution according to claim 8 to which a copper compound is added.

15. The method for forming the connecting portion according to claim 12, wherein the palladium layer has a thickness of 0.05 μm to 0.5 μm and the gold layer has a thickness of 0.05 μm to 0.2 μm.

16. The method for forming the connecting portion according to claim 14, wherein the palladium layer has a thickness of 0.05 μm to 0.5 μm and the gold layer has a thickness of 0.05 μm to 0.2 μm.

17. The method for forming the connecting portion according to claim 14, wherein the palladium layer has a thickness of 0.05 μm to 0.5 μm and the gold layer has a thickness of 0.05 μm to 0.2 μm.
